(19) United States
(12) Patent Application Publication
(10) Pub. No.: US 2014/0130257 A1
(43) Pub. Date: May 15, 2014

(54) PERSON SUPPORT SURFACE

(71) Applicant: Hill-Rom Services, Inc., Batesville, IN (US)

(72) Inventors: Michael M. FRONDORF, Lakeside Park, KY (US); Christopher R. O'KEEFE, Columbus, OH (US); Mark LANNING, Mt. Pleasant, SC (US)

(73) Assignee: Hill-Rom Services, Inc., Batesville, IN (US)

(21) Appl. No.: 14/159,697

(22) Filed: Jan. 21, 2014

Related U.S. Application Data
(63) Continuation of application No. 13/249,689, filed on Sep. 30, 2011.

(51) Int. Cl. A61G 7/015

(52) U.S. Cl. CPC A61G 7/015
USPC 5/618; 5/613

(57) ABSTRACT

A person support surface configured to maximize pressure relief when the various portions of the support surface are at an angle with respect to a reference plane.

### RELATED APPLICATIONS

This application is a continuation of U.S. patent application Ser. No. 13/249,689, filed Sep. 30, 2011, which is incorporated herein by this reference.

### BACKGROUND OF THE DISCLOSURE

This disclosure relates generally to person support surfaces. More particularly, but not exclusively, one illustrative embodiment relates to person support surfaces configured to support a person thereon when the head and torso support section is at an angle with respect to a reference plane. While various person support surfaces have been developed, there is still room for improvement. Thus, a need persists for further contributions in this area of technology.

### SUMMARY OF THE DISCLOSURE

In one illustrative embodiment, a person support surface comprises a first support section and a second support section. The first support section and the second support section are formed such that the first support section is at an angle with respect the second support section in a first position and is configured to move from the first position to a second position where the first support section and the second support section are substantially co-planar. The interface between the first support section and the second support section is in a neutral state in the first position and in compression in the second position.

In another illustrative embodiment, a person support surface comprises a first support section and a second support section. The first support section is at an angle with respect the second support section in a neutral state. The first support section is configured to move from the neutral state to a second position where the first support section is substantially co-planar with the second support section.

In another illustrative embodiment, a person support surface including a first support section and a second support section comprises a first surface and a second surface spaced apart from the first surface. The first support section of the first surface is a first length and the first support section of the second surface is a second length. The second length is greater than the first length. The first support section is movable from a first position where the first support section is at an angle with respect to the second support section and is in a neutral state to a second position where the first support section is substantially co-planar with the second support section.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout:

FIG. 1 is a perspective view of a person support system with a person support surface according to one illustrative embodiment supported on a person support apparatus;

FIG. 2 is a cross-sectional view of the person support surface and deck of FIG. 1 showing the cover and the mattress core in a reclined configuration;

FIG. 3 is a cross-sectional side view of a portion of the person support surface of FIG. 1 showing the top ticking, fire barrier, and bottom ticking of the cover, and the mattress core;

FIG. 4 is a side view of the cover of FIG. 2 according to one illustrative embodiment, showing the sides of various sections having at least one diagonal end;

FIG. 5 is a side view of the cover of FIG. 4 showing the various sections of the sides coupled together such that they are in the reclined configuration;

FIG. 6 is a side view of the cover of FIG. 4 showing the various sections of the sides coupled together and in a substantially planar configuration with the excess material collected proximate to the bend points;

FIG. 7 is a side view of the mattress core of FIG. 2 according to one illustrative embodiment in the reclined configuration with a plurality of relief cuts therein;

FIG. 8 is a side view of the core of FIG. 7 showing the core in a substantially planar configuration;

FIG. 9 is a cross-sectional side view of the person support surface of FIG. 1 according to another illustrative embodiment showing a mattress core including a frame and a plurality of bladders;

FIG. 10 is a cross-sectional side view of the person support surface of FIG. 1 according to another illustrative in the reclined configuration and including a plurality of oval bladders at a first pressure positioned proximate to the bend points; and

FIG. 11 is a cross-sectional side view of the person support surface of FIG. 10 in the substantially planar configuration with the plurality of oval bladders at a second pressure and excess material collected proximate to the bend points.

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

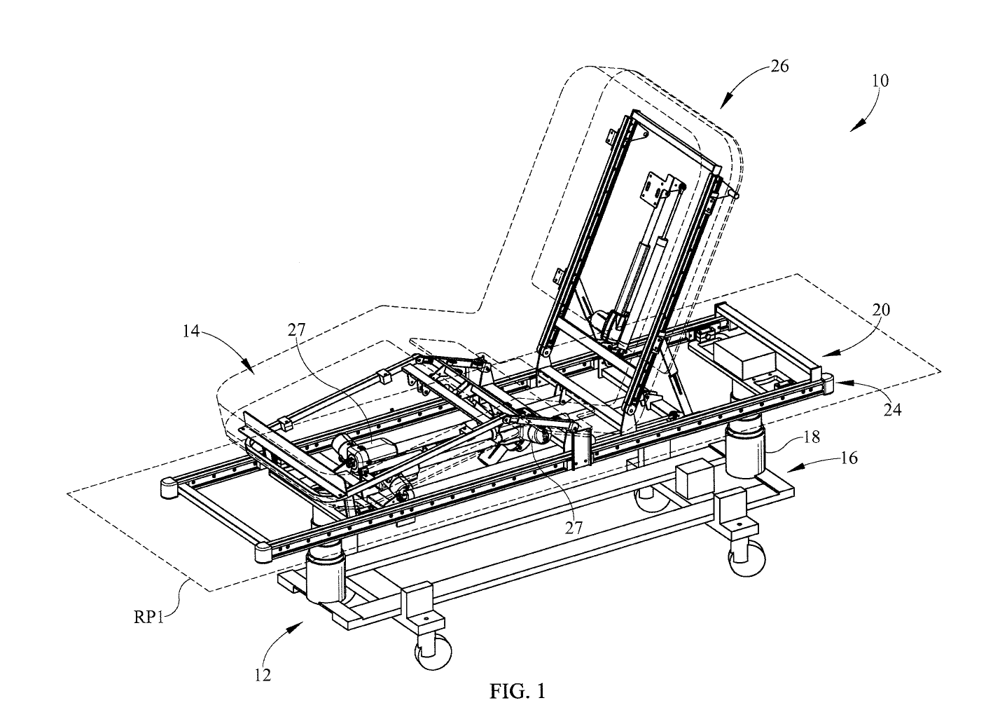

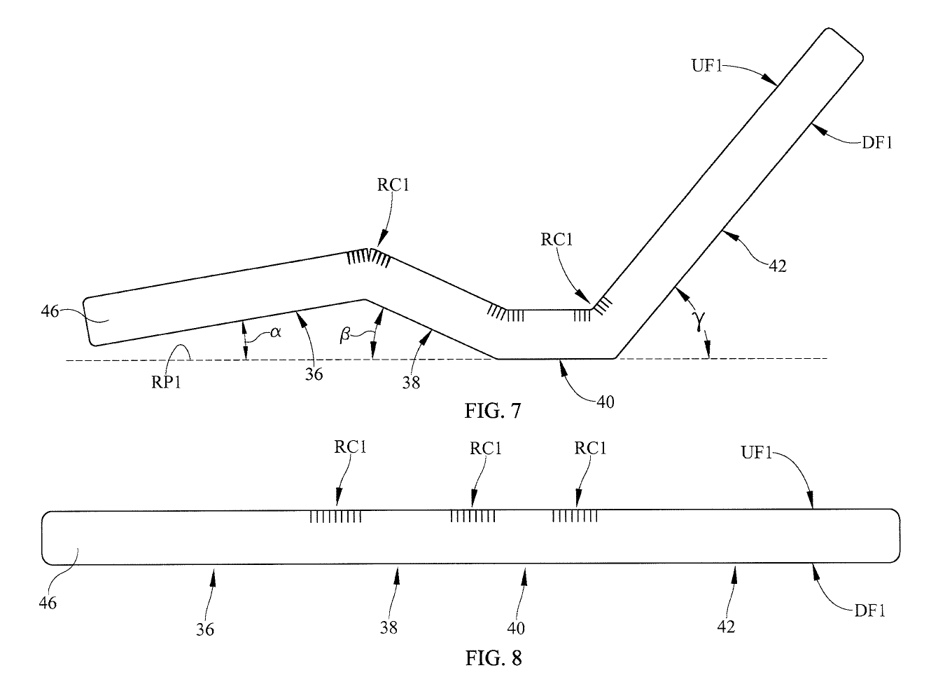

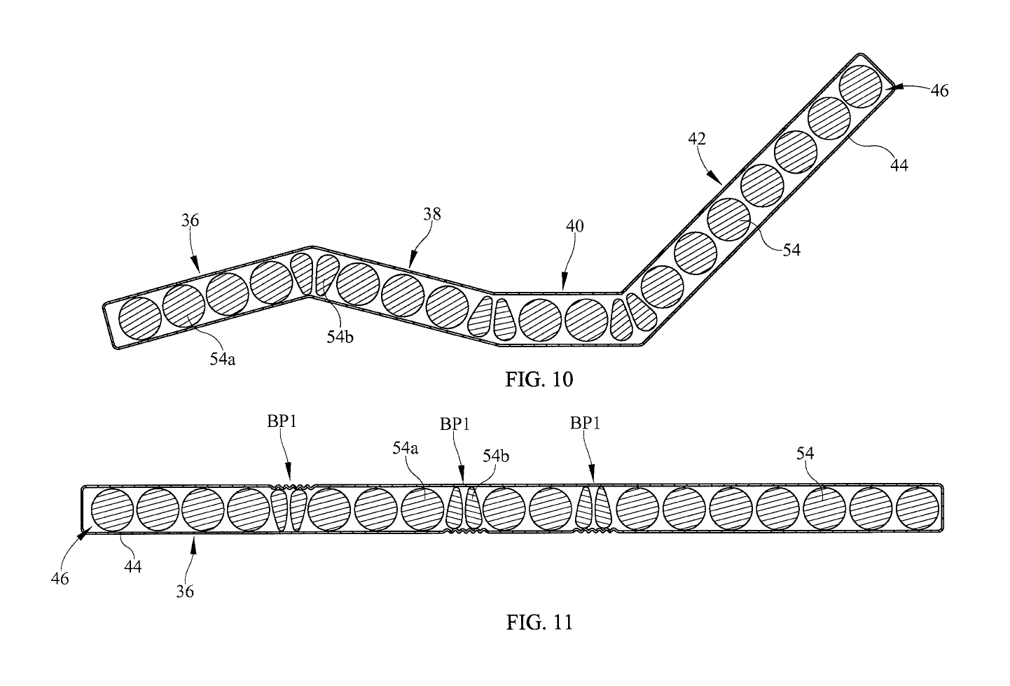

A person support system 10 according to one illustrative embodiment of the current disclosure is shown in FIGS. 1-10. The person support system 10 includes a person support apparatus 12 and a person support surface 14 or mattress 14 supported on the person support apparatus 12. In one illustrative embodiment, the person support apparatus 12 is a hospital bed frame and the mattress 14 is supported thereon. In some contemplated embodiments, the person support apparatus 12 can also be a stretcher, an operating room table, a wheel chair, or other person supporting structure. The person support apparatus 12 includes a lower frame 16, supports 18 or lift mechanisms 18 coupled to the lower frame 16, and an upper frame 20 movably supported above the lower frame 16 by the supports 18 as shown in FIG. 1. The lift mechanisms 18 are configured to raise and lower the upper frame 20 with respect to the lower frame 16 and move the upper frame 20 between various orientations, such as, Trendellenburg and reverse Trendellenburg.

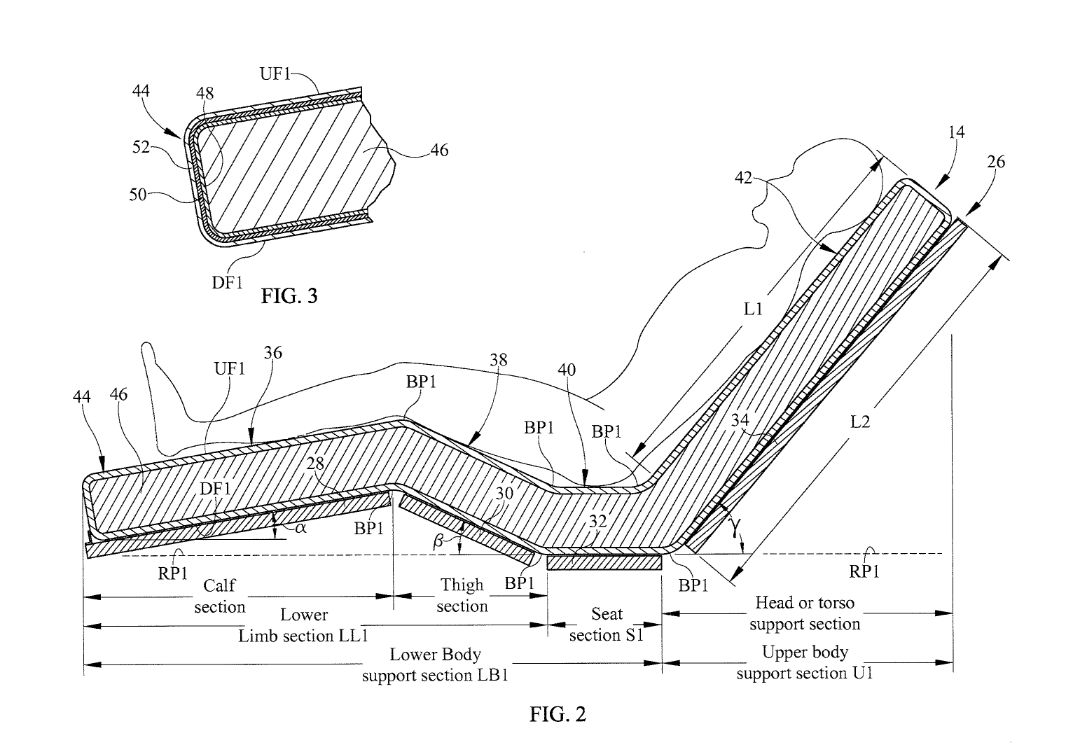

The upper frame 20 includes an upper frame base 24, a deck 26 coupled to the upper frame base 24, and a plurality of actuators 27 coupled to the upper frame base 24 and the deck 26 as shown in FIG. 1. The plurality of actuators 27 are configured to move at least a portion of the deck 26 between various articulated configurations with respect to the upper frame base 24. The deck 26 includes a calf section 28, a thigh section 30, a seat section 32, and a head and torso section 34 as shown in FIG. 2. The calf section 28 and the thigh section 30 define a lower limb support section LL1. The head and torso section 34 define an upper body support section U1. The seat section 32 defines the seat section S1. The calf section 28, the thigh section 30, and the seat section 32 define a lower body support section LB1. At least the calf section 28, the thigh section 30, and the head and torso section 34 are movable with respect to one another and/or the upper frame base 24. In one illustrative embodiment, the calf section 28, the thigh section 30, the seat section 32, and the head and torso section 34 cooperate to move the person support apparatus 12 between an substantially planar or lying down configuration and a chair configuration. In another illustrative embodiment, the calf section 28, the thigh section 30, the seat section 32, and the head and torso section 34 cooperate to move the person support apparatus 12 between a substantially planar or lying down configuration and an angled or reclined configuration. In yet another illustrative embodiment, the head and torso section 34 is moved such that it is at an angle of at least about 30° with respect to a reference plane RP1 passing through the upper frame 20.

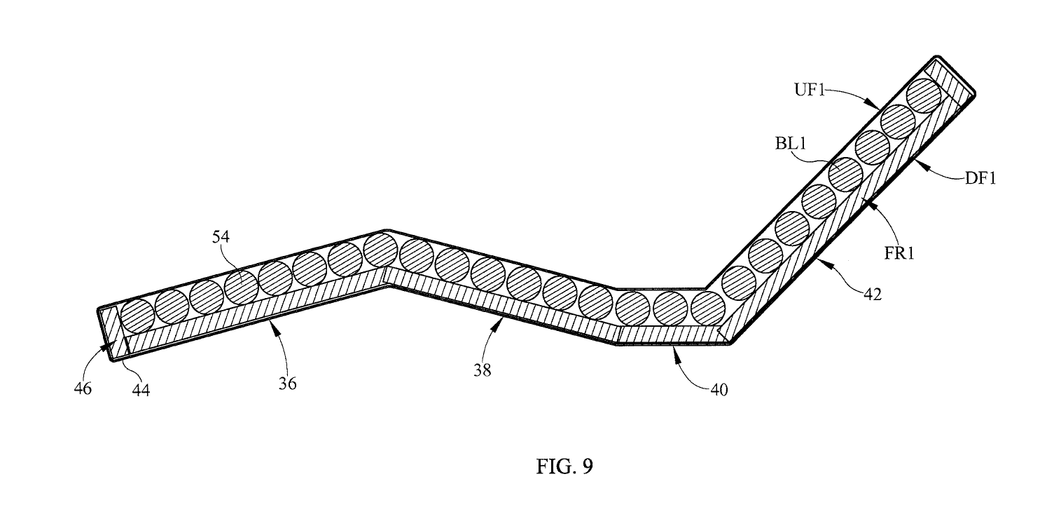

The person support surface 14 is configured to support a person thereon and move with the deck 20 between the various configurations. The person support surface 14 includes a calf portion 36, a thigh portion 38, a seat portion 40, and a head and torso portion 42 as shown in FIGS. 2-10, which are supported on corresponding sections of the deck 26. In one illustrative embodiment, the person support surface 14 is a non-powered (static) surface as shown in FIGS. 2 and 7-9. In another illustrative embodiment, the person support surface 14 is a powered (dynamic) surface as shown in FIG. 9-11, which is configured to receive an input, such as, fluid from a fluid supply (not shown), that can change a characteristic of the surface.

The person support surface 14 includes a mattress cover 44 and a mattress core 46 as shown in FIGS. 2 and 3. In other contemplated embodiments, the person support surface 14 includes a temperature and moisture regulating topper (not shown) coupled to the mattress cover 44. The mattress cover 44 encloses the mattress core 46 and includes a fire barrier 48, a bottom ticking 50 or durable layer 50, and a top ticking 52. In one illustrative embodiment, the fire barrier 48 is the innermost layer of the cover 44, the top ticking 52 is the outermost layer, and the bottom ticking 50 is positioned between the fire barrier 48 and the top ticking 52 and is not coupled to the top ticking 52. The bottom ticking 50 and the top ticking 52 are vapor and air impermeable. In one illustrative embodiment, the top ticking 52 and the bottom ticking 50 are composed of polyurethane coated nylon and the bottom ticking 50 is configured to facilitate movement of the top ticking 52 with respect to the fire barrier 48. In other embodiments, the top ticking 52 and/or the bottom ticking 50 can be air and/or moisture permeable.

The mattress core 46 can be composed of a single type of material or a combination of materials and/or devices. In the case of a powered surface, the mattress core 46 includes at least one fluid bladder 54 therein that receives fluid from a fluid supply (not shown) to maintain the fluid pressure within the fluid bladder 54 at a predetermined level. In some contemplated embodiments, the powered surface can include non-powered components, such as, foam as shown in FIG. 9. In the case of a non-powered surface, the mattress core 46 is composed of a cellular engineered material, such as, single density foam. In some contemplated embodiments, the mattress core 46 includes at least one bladder 54, such as, a static air bladder or a static air bladder with foam contained therewithin, a metal spring and/or other non-powered support elements or combinations thereof. In some contemplated embodiments, the mattress core 46 and includes multiple zones with different support characteristics configured to enhance pressure redistribution as a function of the proportional differences of a person's body. Also, in some embodiments, the mattress core 46 includes various layers and/or sections of foam having different impression load deflection (ILD) characteristics, such as, in the NP 100 Prevention Surface, AccuMax Quantum™ VPC Therapy Surface, and NP200 Wound Surfaces sold by Hill-Rom®.

The mattress cover 44 and/or the mattress core 46 can be configured in a number of ways to maximize pressure relief when the various portions, such as, the calf portion 36, thigh portion 38, and head and torso portion 42, are at an angle with respect to the reference plane RP1. One way to maximize pressure relief is to design the mattress 14 such that the mattress 14 is in a neutral or rest state in the angled configuration. In some contemplated embodiments, the mattress 14 is in a neutral or rest state when the tension and compression in the various sections and/or intersections of the various sections is minimized. In some contemplated embodiments, the mattress 14 is in a neutral or rest state when there is substantially no tension or compression at the intersections of the various sections.

Mattresses are generally designed to maximize pressure relief when the mattress is in the substantially planar configuration. In those cases, the various portions of upwardly facing surface UF1, which are configured to interface with an occupant, are substantially the same length as the corresponding portions of the downwardly facing surface DF1, which is configured to contact the corresponding portions of a deck. When the person support surface 14 is positioned in the angled or chair configuration, the upwardly facing surfaces UF1 and the downwardly facing surfaces DF1 of various sections are a different length. For example, in one illustrative embodiment, when the person support surface 14 is in the angled configuration, the length of the upwardly facing surface UF1 of the head and torso portion 42 (from the intersection of the seat portion 36 and the head and torso portion 42 to the end of the torso portion 42) is a first length L1 and the downwardly facing surface DF1 of the head and torso portion 42 (from the intersection of the seat portion 36 and the head and torso portion 42 to the end of the head and torso portion 42) is a second length L2, which is longer than the first length L1. In another example, when the person support surface 14 is in the angled configuration, the upwardly facing surface UF1 of the calf portion 36 (from the intersection of the calf portion 36 and the thigh portion 38 to the end of the calf portion 36) is a first length L1 and the downwardly facing surface DF1 of the calf portion 36 (from the intersection of the calf portion 36 and the thigh portion 38 to the end of the calf portion 36) is a second length L2, which is shorter than the first length L1.

The cover 44 can be configured a number of ways to account for the different lengths. In one illustrative embodiment, at least one portion of the cover 44, such as, the intersection of the seat section 40 and the head and torso section 42, includes material that is configured to expand/contract to account for the different lengths of material required to cover the upper body support section U1 and lower body support sections LB1. In another illustrative embodiment, the portions of the cover 44, such as, the calf portion 36, the thigh portion 38, the seat portion 40, and the head and torso portion 42, are sized independent of one another such that each portion of the upwardly facing surface UF1 and the corresponding downwardly facing surface DF1 has a different length. In another illustrative embodiment, the portions can be connected together via an elastic material that stretches to account for the different lengths of material.

In another illustrative embodiment, the excess material of the cover 44 can be collected, for example, by pleating, gathering, or folding, at the bend points BP1 of the mattress 14, i.e., where the portions are connected to one another, to account for the different lengths of material. In other contemplated embodiments, an elastic strap (not shown) is used to collect the excess material. In one example, excess material on the downwardly facing surface DF1 at about the intersection of the head and torso support portion 42 (or the material on the upwardly facing surface UF1 at about the intersection of the calf portion 36 and the thigh portion 38) can be configured to collect when the mattress 14 is in the substantially planar configuration and expand when the mattress 14 moves from the substantially planar configuration to the angled configuration. In some contemplated embodiments, excess material is collected in areas where the interface pressure is comparatively lower, such as, behind the occupant's knee.

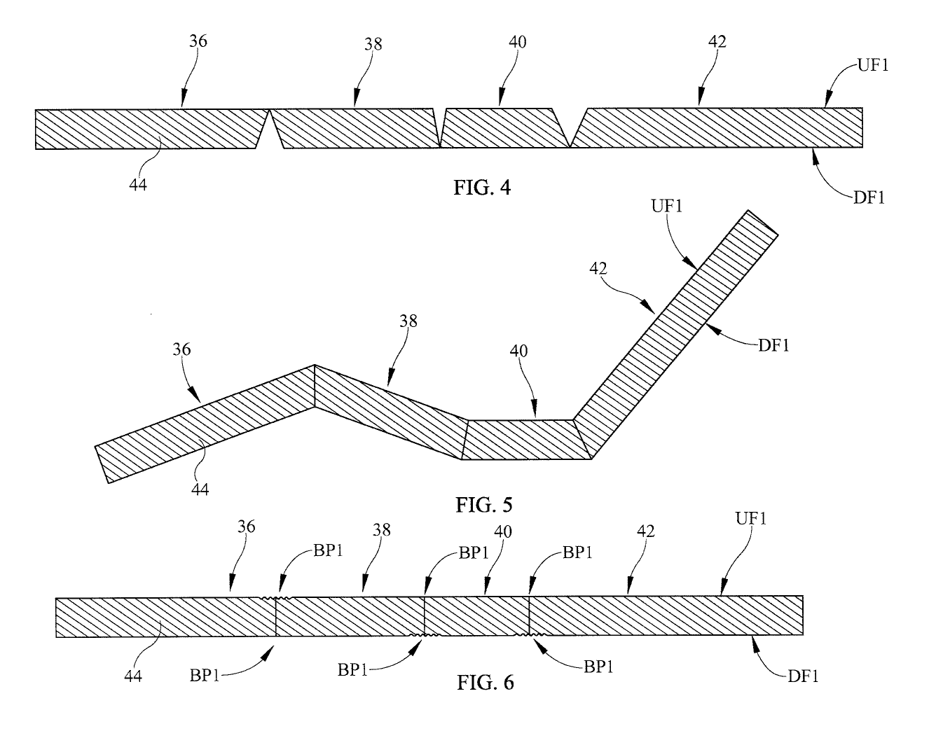

In yet another illustrative embodiment, the sides of the mattress 14 can be formed such that when they are coupled, i.e., via welding or stitching, to one another they mimic the profile of the mattress 14 when it is in the angled configuration as shown in FIGS. 4-6. In one example, the calf portion 36 and head and torso portion 42 are formed with one angled or diagonal end and the thigh portion 38 and seat portion 40 are formed with both ends angled as shown in FIG. 4. In some contemplated embodiments, the sides of the mattress 14 are formed as part of the upwardly facing surface UF1 or downwardly facing surface DF1.

The mattress core 46 can be configured in a number of ways maximize pressure relief when the various portions, such as, the calf portion 36, thigh portion 38, and head and torso portion 42, are at an angle with respect to the reference plane RP1. In one illustrative embodiment of a non-powered mattress, the mattress core 46 is composed of foam that is molded such that the head and torso section 42 of the mattress core 46 is at an angle α with respect to a reference plane RP1, and the calf portion 36 and the thigh portion 38 are at an angle β and γ, respectively, with respect to the reference plane RP1 when the mattress 14 is in the neutral state. In some contemplated embodiments, angle α is between about 25° and about 45° with respect to the reference plane RP1, and angle β and γ are between about 10° and 20° with respect to the reference plane RP 1. In other contemplated embodiments, the mattress core 46 is molded such that the magnitude of angles α, β and γ are greater than 0° with respect to the reference plane RP1. The molded mattress core 46 includes relief cuts RC1 that assist the portions of the mattress 14 in moving from the angled configuration to the substantially planar configuration. In some contemplated embodiments, the relief cuts RC1 are located on only one of the upwardly facing surface UF1 and the downwardly facing surface DF1 of the mattress core 46 and are configured to expand/compress as the mattress 14 is moved from the angled configuration to the substantially planar configuration. In some contemplated embodiments, the relief cuts RC1 are located on both the upwardly facing surface UF1 and the downwardly facing surface DF1. In some contemplated embodiments, the mattress core 46 can be pulled or pushed to move between the angled configuration and the substantially planar configuration.

In another illustrative embodiment of a non-powered mattress, the mattress core 46 includes a frame FR1 and a plurality of bladders BL1. The frame FR1 is composed of foam having a relatively high ILD, such as, for example, a rating of about 61. The frame FR1 is configured such that the various portions of the frame FR1, the calf portion 36, the thigh portion 38, the seat portion 40, and the head and torso portion 42, are joined together at the bend points BP1 of the person support surface 14 such that the mattress core 46 is in the angled configuration in the neutral or rest state. The frame FR1 provides support and helps maintain the shape of the mattress 14. In one illustrative embodiment, the frame FR1 helps maintain the various portions of the mattress 14 at angles α, β and γ with respect to the reference plane RP1. The frame FR1 includes a recessed portion that the bladders BL1 are positioned in. In one illustrative embodiment the bladders BL1 are static air bladders that are in fluid communication with one another so that the air in the bladders BL1 can be redistributed when an occupant is supported on the mattress 14 to substantially equalize the air pressure across the array of bladders BL1. In another illustrative embodiment, the bladders BL1 can be configured to receive fluid from a fluid supply (not shown).

In one illustrative embodiment of a powered mattress 14, the mattress core 46 includes a plurality of generally tubular fluid bladders 54, some of which have a substantially round cross-section 54a and some of which have a wedge shaped cross-section 54b. In some contemplated embodiments, the fluid bladders 55b are oval or egg-shaped. In some contemplated embodiments, the fluid bladders 54 can have at least one smaller bladder (not shown) positioned on a larger bladder (not shown) to form a wedge-like profile. In other contemplated embodiments, the mattress core 46 also includes a semi-rigid frame, such as, the frame FR1, that supports the fluid bladders 54a and 54b. When both types of fluid bladder 54a and 54b are fully inflated to a predetermined pressure, the head and torso portion 42 is at an angle with respect to the seat portion 40 and the person support surface is in the neutral or rest state. When the fluid bladders 54b are deflated to a second predetermined pressure, the head and torso portion 42 is substantially co-planar with the seat section 40 and the person support surface 14 is in the substantially planar configuration. Fluid bladders 54b are positioned proximate to the bend points BP1 of the mattress 14 where the various sections intersect one another, such as, where the head and torso support portion 42 intersects the seat portion 40. In some embodiments, the smaller diameter bladder (not shown) is positioned proximate to the inside of the bend point BP1 and the larger diameter bladder (not shown) is positioned proximate to the outside of the bend.

Many other embodiments of the present disclosure are also envisioned. For example, a person support surface including a first support section and a second support section comprises a first surface and a second surface spaced apart from the first surface. The first support section of the first surface is a first length and the first support section of the second surface is a second length. The second length is greater than the first length.

In another example, a person support comprises a core including a first support section and a second support section. The core is shaped such that the first support section is at an angle with respect the second support section in a neutral state. The first support section is configured to move from the neutral state to a second position where the first support section is substantially co-planar with the second support section.

In another example, a person support surface including a first support section and a second support section comprises a cover defining an inner chamber and a core positionable within the inner chamber. The core is formed such that the first support section is initially at an angle with respect the second support section in a first position. The first support section is configured to move from the first position to a second position where the first support section and the second support section are substantially co-planar. The interface between the first support section and the second support section is in a neutral state in the first position and in compression in the second position.

In another example, a person support surface comprises a first support section and a second support section. The first support section and the second support section are formed such that the first support section is at an angle with respect the second support section in a first position and is configured to move from the first position to a second position where the first support section and the second support section are substantially co-planar. The interface between the first support section and the second support section is in a neutral state in the first position and in compression in the second position.

In another example, a person support surface comprises a first support section and a second support section. The first support section is at an angle with respect the second support section in a neutral state. The first support section is configured to move from the neutral state to a second position where the first support section is substantially co-planar with the second support section.

In another example, a person support surface including a first support section and a second support section comprises a first surface and a second surface spaced apart from the first surface. The first support section of the first surface is a first length and the first support section of the second surface is a second length. The second length is greater than the first length. The first support section is movable from a first position where the first support section is at an angle with respect to the second support section and is in a neutral state to a second position where the first support section is substantially co-planar with the second support section.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. A person support surface including a first support section and a second support section, comprising:
a first surface; and
a second surface spaced apart from the first surface, wherein the first support section of the first surface is a first length and the first support section of the second surface is a second length, the second length being greater than the first length, wherein the first support section is movable from a first position where the first support section is at an angle with respect to the second support section and is in a neutral state to a second position where the first support section is substantially co-planar with the second support section.

2. The person support surface of claim 1, wherein the first surface and the second surface cooperate to define a cover.

3. The person support surface of claim 1, wherein at least a portion of the second surface is in compression when the first support section is in the second position.

4. The person support surface of claim 3, wherein excess length of the second surface is collected proximate to the intersection of the first support section and the second support section when the first support section is in the second position.

5. The person support surface of claim 4, wherein excess length is collected by at least one fold in at least one of the second surface and a side surface extending between the first surface and the second surface.

6. The person support surface of claim 1 further includes a side surface extending between the first surface and the second surface, the first support section of the side surface including a diagonal end configured to be coupled to a diagonal end of the second support section of the side surface.

7. The person support surface of claim 6, wherein the first support section is at an angle with respect to a second support section in a neutral state when the diagonal end of the first support section of the side surface is coupled to the diagonal end of the second support section of the side surface.

8. A person support surface, comprising:
a first support section; and
a second support section, the first support section is at an angle with respect the second support section in a neutral state, the first support section being configured to move from the neutral state to a second position where the first support section is substantially co-planar with the second support section.

9. The person support surface of claim 8, wherein the impression load deflection characteristics of a first portion of at least one of the first support section and the second support section are different than the impression load deflection characteristics of a second portion of at least one of the first support section and the second support section.

10. The person support surface of claim 8 further comprising at least one fluid bladder positioned in at least one of the first support section and the second support section, the fluid bladder being configured to receive fluid from a fluid supply.

11. The person support surface of claim 10, wherein the at least one fluid bladder is configured to be at a first pressure when the first support section is in the neutral state and a second pressure when the first support section is moved to the second position.

12. The person support surface of claim 11, wherein at least one fluid bladder has a substantially oval cross-section and is positioned proximate to the intersection of the first support section and the second support section.

13. The person support surface of claim 8 further comprising a third support section, the second support section being coupled between the first support section and the third support section, wherein the first support section is configured to support the upper body of an occupant and the third support section is configured to support the lower limbs of the occupant.

14. The person support surface of claim 8, wherein the first support section and the second support section are composed of a single layer of foam that is molded such that the first support section is at an angle with respect to the second support section in the neutral state.

15. The person support surface of claim 9, wherein the first support section is at an angle of greater than 15° with respect to the second support section in the neutral state.

16. A person support surface, comprising:
a first support section; and
a second support section, the first support section and the second support section being formed such that the first support section is at an angle with respect the second support section in a first position and is configured to move from the first position to a second position where the first support section and the second support section are substantially co-planar, wherein the interface between the first support section and the second support section is in a neutral state in the first position and in compression in the second position.

17. The person support surface of claim 16, wherein at least one of the first support section and the second support section is composed of foam and includes at least one relief cut proximate to the intersection of the first support section and the second support section.

18. The person support surface of claim 16, wherein the first support section is at an angle of between about 30° and about 45° with respect to the second support section in the first position.

19. The person support surface of claim 16, wherein at least one of the first support section and the second support section includes a foam frame including a recessed portion and a plurality of bladders positioned in the recessed portion.

20. The person support surface of claim 16, wherein at least one of the first support section and the second support section includes at least one fluid bladder configured to receive fluid from a fluid supply.
